(19) United States
(12) Patent Application Publication
(10) Pub. No.: US 2025/0063352 A1
(43) Pub. Date: Feb. 20, 2025

(54) INFORMATION PROCESSING METHOD AND APPARATUS, COMMUNICATION DEVICE, AND STORAGE MEDIUM

(71) Applicant: Beijing Xiaomi Mobile Software Co., Ltd., Beijing (CN)

(72) Inventors: Rao SHI, Beijing (CN); Yumin WU, Beijing (CN)

(73) Assignee: Beijing Xiaomi Mobile Software Co., Ltd., Beijing (CN)

(21) Appl. No.: 18/713,935

(22) PCT Filed: Nov. 29, 2021
(86) PCT No.: PCT/CN2021/134136

§ 371 Date: May 28, 2024

(51) Int. Cl. H04W 12/06; H04L 9/32; H04W 48/20; H04W 60/00

(52) U.S. Cl. CPC H04W 12/06; H04L 9/3247; H04W 48/20; H04W 60/00

(57) ABSTRACT

Embodiments of the present disclosure provide an information processing method and apparatus, a communication device, and a storage medium. The method is performed by a UE, and includes: receiving system information; and authenticating a cell which broadcasts the system information based on whether system information carrying Digital Signature (DS) information is received. The system information carrying the DS information is sent by a network device after determining a cell in a preset Tracking Area (TA).

### CROSS REFERENCE TO RELATED APPLICATION

The present application is a U.S. National Stage of International Application No. PCT/CN2021/134136, filed on Nov. 29, 2021, the contents of which are incorporated herein by reference in its entirety.

### TECHNICAL FIELD

The present disclosure relates to but is not limited to the communication technical field, and in particular, to an information processing method and apparatus, a communication device and a storage medium.

### BACKGROUND

Broadcasting of system information is an essential and important part of the New Radio (NR) system. A cell needs to periodically broadcast system information to provide basic information about a serving cell or a neighboring cell, or broadcast system information for User Equipment (UE) to use in cell selection or reselection or to provide Public Warning System (PWS) information to UE(s). This can ensure that a UE can normally camp on the cell and can provide necessary condition(s) for subsequent Radio Resource Control (RRC) connection establishment. For example, before a UE in an RRC idle state performs accessing, the UE needs to perform Public Land Mobile Network (PLMN) selection, cell selection or reselection, or perform admission control, or the like. Information required for these processes is obtained from the system information broadcast by the cell.

The system information is not broadcast for a certain UE, but is periodically sent to all UEs in the cell. In this way, the system information is applicable to all UEs in the cell, and obviously there is no need for excessive security protection. However, if system information is not protected, attackers may tamper with the system information and launch attacks, causing UEs to use wrong system information.

### SUMMARY

Embodiments of the present disclosure provide an information processing method and apparatus, a communication device and a storage medium.

According to a first aspect of the present disclosure, an information processing method is provided. The method is performed by a UE and includes: receiving system information; and authenticating a cell which broadcasts the system information based on whether the system information carrying Digital Signature (DS) information is received, wherein the system information carrying the DS information is sent by a network device after determining a cell in a preset Tracking Area (TA).

According to a second aspect of the present disclosure, an information processing method is provided. The method is performed by a base station and includes: when a cell of the base station is located in a preset TA, broadcasting system information carrying DS information, wherein the DS information is used for UE to authenticate a cell which broadcasts the system information.

According to a third aspect of the present disclosure, an information processing apparatus is provided. The apparatus is applied to a UE and includes: a receiving module configured to receive system information; and a processing module configured to authenticate a cell which broadcasts the system information based on whether the system information carrying DS information is received, wherein the system information carrying the DS information is sent by a network device after determining a cell in a preset TA.

According to a fourth aspect of the present disclosure, an information processing apparatus is provided. The apparatus is applied to a base station and includes: a sending module configured to, when a cell of the base station is located in a preset TA, broadcast system information carrying DS information, wherein the DS information is used for UE to authenticate a cell which broadcasts the system information.

According to a fifth aspect of the present disclosure, a communication device is provided. The communication device includes: a processor; and a memory configured to store instructions executable by the processor; wherein the processor is configured to, when the executable instructions are run, implement the information processing method of any embodiment of the present disclosure.

According to a sixth aspect of the disclosure, a computer storage medium is provided. The computer storage medium stores a computer executable program. When the executable program is executed by a processor, the information processing method of any embodiment of the disclosure is implemented.

It should be understood that the above general description and the following detailed description are only exemplary and explanatory, and are not intended to limit the embodiments of the present disclosure.

### BRIEF DESCRIPTION OF THE DRAWINGS

FIG. 1 is a schematic structural diagram of a wireless communication system.

FIG. 2 is a schematic diagram of a digital signature mechanism according to an example embodiment.

FIG. 3 is a flowchart of an information processing method according to an example embodiment.

FIG. 4 is a flowchart of an information processing method according to an example embodiment.

FIG. 5 is a flowchart of an information processing method according to an example embodiment.

FIG. 6 is a flowchart of an information processing method according to an example embodiment.

FIG. 7 is a flowchart of an information processing method according to an example embodiment.

FIG. 8 is a block diagram of an information processing apparatus according to an example embodiment.

FIG. 9 is a block diagram of an information processing apparatus according to an example embodiment.

FIG. 10 is a block diagram of a UE according to an example embodiment.

FIG. 11 is a block diagram of a base station according to an example embodiment.

FIG. 12 is a flowchart of an information processing method according to an example embodiment.

### DETAILED DESCRIPTION

Example embodiments will be described in detail herein, examples of which are illustrated in the accompanying drawings. When the following description refers to the drawings, the same numbers in different drawings refer to the same or similar elements unless otherwise indicated. The implementations described in the following example embodiments do not represent all implementations consistent with embodiments of the present disclosure. Rather, they are merely examples of apparatuses and methods consistent with some aspects of embodiments of the present disclosure as detailed in the appended claims.

The terms used in embodiments of the present disclosure are for the purpose of describing example embodiments only and are not intended to limit the embodiments of the present disclosure. As used in the embodiments of the present disclosure and the appended claims, the singular forms “a”, “an” and “the” are intended to include a plural form as well, unless the context clearly dictates otherwise. It will also be understood that the term “and/or” as used herein refers to and includes any and all possible combinations of one or more of associated listed items.

It should be understood that although the terms first, second, third, etc. may be used to describe various information in the embodiments of the present disclosure, the information should not be limited to these terms. These terms are only used to distinguish information of the same type from each other. For example, without departing from the scope of the embodiments of the present disclosure, first information may also be called second information, and similarly, second information may also be called first information. Depending on the context, the word “if” as used herein may be interpreted as “when” or “upon” or “in response to determining . . . ”.

FIG. 1 shows a schematic structural diagram of a wireless communication system provided by an embodiment of the present disclosure. As shown in FIG. 1, the wireless communication system is a communication system based on cellular mobile communication technologies. The wireless communication system may include multiple user equipments 110 and multiple base stations 120.

User equipment 110 may be a device that provides voice and/or data connectivity to a user. The user equipment 110 may communicate with one or more core networks via a Radio Access Network (RAN). The user equipment 110 may be an Internet of Things user equipment, such as a sensor device, a mobile phone (or referred to as a “cellular” phone), and a computer with an Internet of Things UE, for example, it can be a fixed, portable, pocket-sized, handheld, computer-built-in or vehicle-mounted device. For example, the user equipment 110 may be a station (STA), a subscriber unit, a subscriber station, a mobile station, a mobile, a remote station, an access point, a remote user equipment (remote terminal), an access user equipment (access terminal), a user terminal, a user agent, a user device, or user equipment. Alternatively, the user equipment 110 may be equipment of an unmanned aerial vehicle. Alternatively, the user equipment 110 may be a vehicle-mounted device, for example, it may be an on-board computer with a wireless communication function, or a wireless user equipment connected to an external on-board computer. Alternatively, the user equipment 110 may be a roadside device, for example, it may be a streetlight, a signal light or other roadside device with a wireless communication function.

A base station 120 may be a network side device in a wireless communication system. The wireless communication system may be the 4th generation mobile communication (4G) system, also known as the Long Term Evolution (LTE) system; or, the wireless communication system may be a 5G system, also called new radio system or 5G NR system. Alternatively, the wireless communication system may be a next-generation system of the 5G system. The access network in the 5G system may be called New Generation-Radio Access Network (NG-RAN).

The base station 120 may be an evolved base station (eNB) used in the 4G system. Alternatively, the base station 120 may be a base station (gNB) using a centralized distributed architecture in the 5G system. When the base station 120 adopts a centralized distributed architecture, it usually includes a central unit (CU) and at least two distributed units (DU). The central unit is provided with a protocol stack including a Packet Data Convergence Protocol (PDCP) layer, a Radio Link Control protocol (RLC) layer, and a Medium Access Control (MAC) layer; a distributed unit is provided with a physical (PHY) layer protocol stack. The embodiments of the present disclosure do not limit the specific implementation of the base station 120.

A wireless connection may be established between a base station 120 and a user equipment 110 through a radio air interface. In different implementations, the radio air interface is a radio air interface based on the fourth generation mobile communication network technology (4G) standard; or, the radio air interface is a radio air interface based on the fifth generation mobile communication network technology (5G) standard, for example, the radio air interface is a new air interface; alternatively, the radio air interface may be a radio air interface based on the next generation mobile communication network technology standard of 5G.

In some embodiments, an End to End (E2E) connection may be established between user equipments 110, for example, vehicle to vehicle (V2V) communication, vehicle to Infrastructure (V2I) communication and vehicle to pedestrian (V2P) communication in vehicle to everything (V2X) and so on.

Here, the user equipment in the above description may be a terminal device in the following embodiments.

In some embodiments, the above-mentioned wireless communication system may also include a network management device 130.

Multiple base stations 12 are connected to the network management device 130 respectively. The network management device 130 may be a core network device in a wireless communication system. For example, the network management device 130 may be a Mobility Management Entity (MME) in an Evolved Packet Core (EPC). Alternatively, the network management device may be other core network devices, such as Serving GateWay (SGW), Public Data Network GateWay (PGW), Policy and Charging Rules Function (PCRF) or Home Subscriber Server (HSS), etc. The embodiments of the present disclosure do not limit the implementation form of the network management device 130.

In order to facilitate understanding by those skilled in the art, embodiments of the present disclosure enumerate multiple implementations to clearly describe the technical solutions of the embodiments of the present disclosure. Of course, those skilled in the art can understand that the multiple embodiments provided in the present disclosure can be performed alone or in combination with methods of other embodiments in the present disclosure, or the multiple embodiments provided in the present disclosure may be performed alone or in combination together with some methods in other related art, and no specific limitations are imposed on this.

Some corresponding protection mechanisms are introduced to protect system information broadcast over the air interface. For example, a Digital Signature (DS) authentication mechanism is introduced in system information. However, for the introduction of an enhanced function, considering the evolution of the NR version, a situation where enhanced cells and legacy cells coexist may appear. If a fake base station only broadcasts fields of system information itself and indicates that a cell of the current fake base station is a legacy cell, the protection mechanism cannot prevent attacks from the fake base station.

In order to better understand the technical solutions described in any embodiment of the present disclosure, the digital signature authentication introduced for system information in related art will be described first.

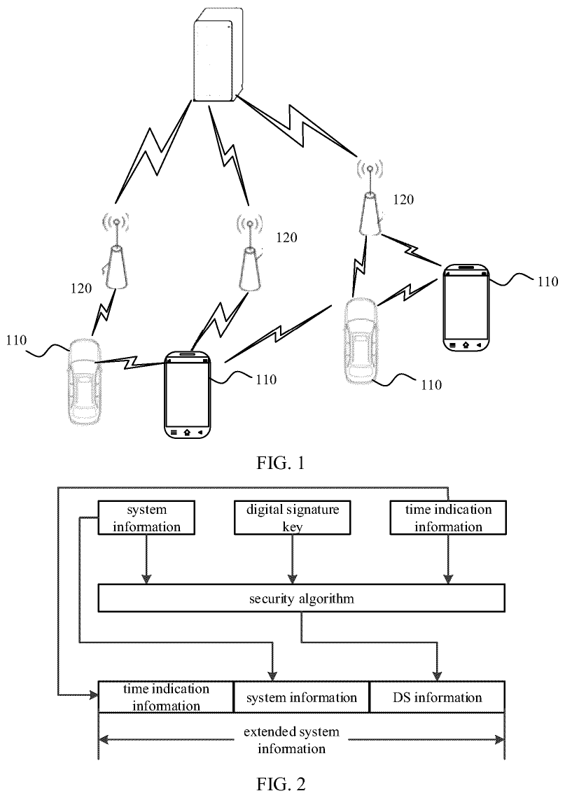

As shown in FIG. 2, in an embodiment, extended system information is generated by a security algorithm based on system information, a digital signature key (K-SIG) and time indication information. The extended system information includes: system information, DS information and time indication information. The extended system information is sent. When a UE performs cell reselection, if the UE receives the extended system information, the UE determines whether the system information is attacked system information based on a K-SIG which the UE already has and the DS information in the extended system information.

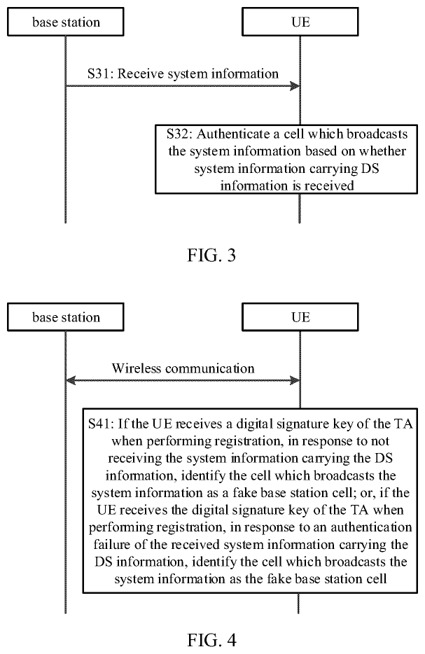

As shown in FIG. 3, an embodiment of the present disclosure provides an information processing method. The method is performed by a UE and includes the following steps S31 and S32.

In step S31, system information is received.

In step S32, a cell which broadcasts the system information is authenticated based on whether the system information carrying DS information is received.

Here, the system information carrying DS information is sent by a network device after determining a cell in a preset Tracking Area (TA).

In an embodiment, the system information carrying the DS information may also be sent by a cell in the TA determined by the network device.

In an embodiment, the system information carrying the DS information may also be sent after a base station determines that a cell of the base station is a cell in the preset TA.

The network device may be a core network device or an access network device. Here, the access network device may be a base station, etc. The core network device may be various functional entity (entities), etc., for example, the core network device may be Access and Mobility Management Function (AMF).

The UE may be of various types. For example, the UE may be but is not limited to a mobile phone, a tablet computer, a wearable device, a smart home device, a smart office device, a game control platform or a multimedia device, etc.

Receiving the system information in step S31 may be: receiving the system information sent by the base station. The system information may be system information carrying the DS or system information not carrying the DS.

The base station may be of various types, such as a 2G base station, a 3G base station, a 4G base station, a 5G base station or other evolved base station.

The system information may be of various types. For example, the system information may be but is not limited to: SIB1, SIB2, . . . , and/or SIBx.

In an embodiment, the DS information carried in the system information is DS information for the preset TA. For example, the base station broadcasts system information, and the system information carries DS information for the preset TA.

The UE may be one or more UEs in a cell of the base station.

In some embodiments, the TA may be at least one of the following: a TA where a cell which the UE camps on is located; a part of one or more TAs in a Registration Area (RA) of the UE; all of one or more TAs in the RA of the UE; or a TA in a TA list, wherein the TA list is a TA list in the RA.

Here, an RA may include one or more TA lists, one TA list includes one or more TAs. Alternatively, an RA may include one or more TAs.

Here, one TA may include one or more cells.

In some embodiments, the digital signature information includes: a digital signature key; or the digital signature information includes: the digital signature key and time indication information; where the time indication information is used to indicate validity time of the digital signature key.

An embodiment of the present disclosure provides an information processing method performed by a UE. The method may include: based on whether system information carrying the DS information is received, identifying, by the UE, whether the cell which broadcasts the system information is a fake base station cell.

In the embodiments of the present disclosure, the system information can be received through the UE, and the cell which broadcasts the system information can be authenticated based on whether the system information carrying the Digital Signature (DS) information is received. The system information carrying the DS information is sent by the network device after determining a cell in the preset Tracking Area (TA). In this way, embodiments of the present disclosure can enable the UE to accurately authenticate the cell which broadcasts the system information based on whether the UE receives the system information carrying the DS information.

And, the system information carrying the DS information is sent by the cell in the preset TA determined by the network device. After receiving the system information, the UE can authenticate the cell in the TA based on the digital signature information corresponding to the TA. This solution makes it more difficult for other fake base station cell(s) to impersonate the cells in the TA to broadcast the system information, thereby reducing the risk of the UE being attacked by the fake base station cell(s).

Here, the UE may authenticate the cell based on the digital signature key of the TA where the current cell is located and the DS included in the system information. That is, cell authentication can be performed for cell(s) within a TA based on the digital signature information corresponding to the TA.

Moreover, in embodiments of the present disclosure, one piece of DS information may be applied for cell(s) in the entire preset TA. In this way, the same digital signature information may be used for the entire preset TA for authentication.

Moreover, in embodiments of the present disclosure, the range of cell(s) for which the DS needs to be provided for authentication is specified. For example, it may be the TA where the cell which the UE camps on is located, or one or more TAs in the registration area, or one or more TA lists, and so on.

In an embodiment, when performing registration to a cell, the UE may obtain at least one of the following information from a core network device:

TA information of a TA where the cell to which the UE registers is located; a correspondence relationship between the TA information of the TA where the cell to which the UE registers is located and the K-SIG of the TA; identity information of the cell to which the UE registers; or a correspondence relationship between the identity information of the cell to which the UE registers and the TA information of the TA.

In another embodiment, the UE may further receive at least one of the following information sent by the base station: TA information of each TA; a correspondence relationship between the TA information of each TA and the K-SIG of the TA; identity information of each cell; or a correspondence relationship between the identity information of each cell and the TA information.

In an embodiment, the system information included in step S31 may be system information carrying first information, where the first information includes TA information of a TA where a cell of the base station is located.

In this way, after the UE receives the system information, the UE may determine, based on the TA information carried in the system information and the TA information of the TA included in the UE, whether the cell which broadcasts the system information is located in the TA where the current cell (that is, the cell which the UE is camping on) is located; and/or, based on the DS information carried in the system information and the DS information obtained based on the K-SIG of the TA in the UE, the UE may determine whether the cell which broadcasts the system information is located in the TA where the current cell is located. If the cell which broadcasts the system information is not located in the TA where the current cell is located, and/or the DS information carried in the system information matches the DS information obtained based on the K-SIG of the TA in the UE, it may be determined that the cell which broadcasts the system information is a fake base station cell.

In this way, the cell which broadcasts the system information can be authenticated based on the digital signature key of the TA where the current cell of the UE is located, which makes it more difficult for fake base station cell(s) to impersonate a cell in the TA, thereby improving the accuracy of authentication.

In an embodiment, the system information included in step S31 may be system information carrying second information, where the second information includes identity information of a cell of the base station.

In this way, after the UE receives the system information, it may determine, based on the identity information of the cell carried in the system information and a correspondence relationship between cell identity information and TA information included in the UE, whether the cell which broadcasts the system information is located in the TA where the current cell is located. If the cell which broadcasts the system information is not located in the TA where the current cell is located, it is determined that the cell which broadcasts the system information is a fake base station cell. If the cell which broadcasts the system information is located in the TA where the current cell is located, the DS information carried in the system information is compared with the DS information obtained based on the K-SIG of the TA in the UE. If the DS information carried in the system information does not match the DS information obtained based on the K-SIG of the TA in the UE, it is determined that the cell which broadcasts the system information is a fake base station cell. If the DS information carried in the system information matches the DS information obtained based on the K-SIG of the TA in the UE, it is determined that the cell which broadcasts the system information is not a fake base station cell.

In this way, the cell which broadcasts the system information can be authenticated based on the TA where the current cell of the UE is located and the digital signature key corresponding to the TA. This makes it more difficult for fake base station cell(s) to impersonate a cell of the TA, thereby improving the accuracy of authentication.

In some embodiments, step S32 includes: if the UE receives the digital signature key of the TA when performing registration, in response to not receiving the system information carrying the DS information, identifying the cell which broadcasts the system information as a fake base station cell; if the UE receives the digital signature key of the TA when performing registration, in response to an authentication failure of the received system information carrying the DS information, identifying the cell which broadcasts the system information as a fake base station cell.

An embodiment of the present disclosure provides an information processing method performed by the UE. The method may include: if the digital signature key of the TA exists in the UE, based on that system information carrying the DS information is not received, identifying the cell which broadcasts the system information as a fake base station cell; r, if the digital signature key of the TA exists in the UE, based on an authentication failure of the received system information carrying the DS information, identifying the cell which broadcasts the system information as a fake base station cell.

Here, the digital signature key of the TA existing in the UE includes but is not limited to one of the following cases where: the UE receives the digital signature key of the TA when performing registration; the UE receives a digital signature key of each TA sent by the base station; or the UE receives a correspondence relationship between a digital signature key and TA information of each TA sent by the base station.

As shown in FIG. 4, an embodiment of the present disclosure provides an information processing method. The method is performed by the UE and may include step S41.

In step S41, if the UE receives the digital signature key of the TA when performing registration, in response to not receiving the system information carrying the DS information, the cell which broadcasts the system information is identified as a fake base station cell; or, if the UE receives the digital signature key of the TA when performing registration, in response to an authentication failure of the received system information carrying the DS information, the cell which broadcasts the system information is identified as a fake base station cell.

Here, when the UE initially registers with a cell, it may obtain from a core network device a digital signature key of a TA where the cell is located.

As an example, during the registration procedure, the UE obtains the K-SIG of the TA where the cell which the UE registers to is located; if the UE does not receive the system information carrying the DS information, the UE determines that the cell which broadcasts the system information is a fake base station cell.

In this way, in the embodiment of the present disclosure, when the UE has the K-SIG of the TA, if the UE does not receive the system information carrying the DS information, it means that the system information has not passed the authentication of the digital signature, so that the cell which broadcasts the system information can be accurately identified as a fake base station cell.

As an example, during the registration procedure, the UE obtains the K-SIG of the TA where the registered cell is located; if the UE receives the system information carrying the DS information, the UE compares the DS information obtained based on the K-SIG in the UE with the DS information carried in the received system information; if the DS information obtained by the UE based on the K-SIG does not match the DS information carried in the system information, the cell which broadcasts the system information is identified as a fake base station cell.

Here, the UE obtaining the DS information based on the K-SIG includes: generating, by the UE, the DS information from the K-SIG existing in the UE based on an algorithm related to the digital signature. The algorithm related to the digital signature may be any security algorithm, as long as the algorithm related to the digital signature is the same as the algorithm used to generate the DS information in the system information.

Here, the DS information obtained by the UE based on the K-SIG not matching the DS information carried in the system information includes at least one of the following cases where: the DS information obtained based on K-SIG in the UE is not the same as the DS information carried in the system information; or the current time is not within a range of the validity time of the K-SIG indicated by the time indication information in the DS information.

In this way, in the embodiment of the present disclosure, when the UE has the K-SIG of the TA, if the UE receives the system information carrying the DS information, but the authentication based on the system information carrying the DS information fails, it means that the system information does not use the same digital signature as the TA. In this way, it can be accurately identified that the cell which broadcasts the system information is a fake base station cell.

An embodiment of the present disclosure provides an information processing method performed by the UE. The method may include: if the UE receives the digital signature key of the TA when performing registration, in response to an authentication success of the received system information carrying the DS information, identifying that the cell which broadcasts the system information is not a fake base station cell.

As an example, during the registration procedure, the UE obtains the K-SIG of the TA where the cell which the UE registers to is located; if the UE receives system information carrying the DS information, the UE compares the DS information obtained based on the K-SIG in the UE with the DS information carried in the received system information; if the DS information obtained by the UE based on the K-SIG matches the DS information carried in the system information, it is identified that the cell which broadcasts the system information is not a fake base station cell.

Here, the DS information obtained based on the K-SIG in the UE matching the DS information carried in the system information includes one of the following cases where: the DS information obtained based on the K-SIG in the UE is the same as the DS information; or the DS information obtained based on the K-SIG in the UE is the same as the DS information, and the current time is within the range of the validity time of the K-SIG indicated by the time indication information in the DS information.

In this way, in the embodiment of the present disclosure, when the UE has the K-SIG of the TA, if the UE receives the system information carrying the DS information, and the authentication based on the system information carrying the DS information is successful, it means that the system information uses the same digital signature as the digital signature of the TA. In this way, it can be accurately identified that the cell which broadcasts the system information is not a fake base station cell.

It should be noted that those skilled in the art can understand that the methods provided in the embodiments of the present disclosure can be performed alone or together with some methods in embodiments of the present disclosure or some methods in related art.

In some embodiments, in response to not receiving the system information carrying the DS information, identifying the cell which broadcasts the system information as a fake base station cell in step S41 includes one of the following: in response to an authentication failure of any system information carrying the DS information, identifying the cell which broadcasts the system information as the fake base station cell; or in response to authentication failures of more than a predetermined number of pieces of system information carrying the DS information, identifying the cell which broadcasts the system information as the fake base station cell.

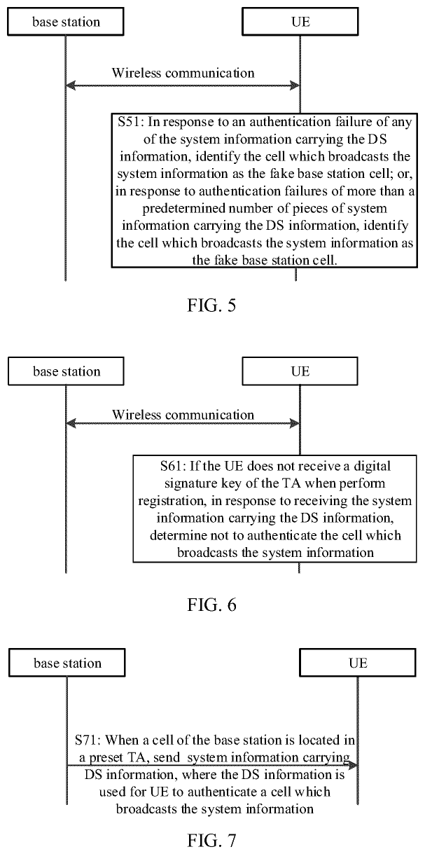

As shown in FIG. 5, an embodiment of the present disclosure provides an information processing method. The method is performed by the UE and may include step S51.

In step S51, in response to an authentication failure of any system information carrying the DS information, the cell which broadcasts the system information is identified as a fake base station cell; or, in response to authentication failures of more than a predetermined number of pieces of system information carrying the DS information, the cell which broadcasts the system information is identified as the fake base station cell.

Here, the UE receives multiple pieces of system information carrying the DS information. If the authentication of any one of the pieces of system information carrying the DS information fails, the cell which broadcasts the system information is identified as a fake base station cell; or if the authentication of more than a predetermined number of pieces of system information carrying the DS information fails, the cell which broadcasts the system information is identified as a fake base station cell.

The predetermined number may be set by the network side, or may be determined through negotiation with the network side. The network side here refers to a network device, which may be a network device or an access network device. Here, the access network device may be, but is not limited to, a base station; the core network device may be, but is not limited to, an entity such as a Network Function (NF).

As an example, if the UE receives multiple pieces of system information carrying the DS information, for example, the UE receives a Public Warning System (PWS) message, SIB6 and SIB7, when the authentication based on any one of the PWS message, SIB6 and SIB7 fails, the cell which sends the pieces of system information is identified as a fake base station cell. For example, although the authentication of the PWS message and SIB7 is successful, if an attacker attacks SIB6, it is determined that the cell which sends these pieces of system information is a fake base station cell.

As an example, if the UE receives multiple pieces of system information carrying the DS information, for example, the UE receives SIB2, SIB3, SIB4, SIB5 and SIB6, and the network side sets the predetermined number to be two, when the authentication of more than two pieces of system information among these pieces of system information fails, the cell which sends the system information is identified as a fake base station cell. For example, if the UE receives five pieces of system information (SIB2, SIB3, SIB4, SIB5 and SIB6) carrying the DS information, when the authentication based on three or more of the system information fails, it indicates that the credibility of the cell which broadcasts the system information is not high, and the cell which broadcasts the system information is identified as a fake base station cell.

In the above example, if the UE receives five pieces of system information (SIB2, SIB3, SIB4, SIB5 and SIB6) carrying the DS information, and only authentication of one or two of these pieces of information fails, the cell which broadcasts these pieces of system information is not identified as a fake base station cell.

In some embodiments, the method includes: discarding the system information, authentication of which fails. For example, in the above example, when multiple pieces of system information carrying the DS information are received, if authentication based on one of the pieces of system information fails, it is needed to discard the system information, authentication of which fails, regardless of whether the cell which broadcasts the system information is identified as a fake base station cell or not.

In the embodiments of the present disclosure, if the K-SIG exists in the UE and multiple pieces of system information carrying the DS information are received, whether the cell which sends these pieces of system information is a fake base station cell can be accurately determined based on the number of pieces of system information the authentication of which fails.

An embodiment of the present disclosure provides an information processing method. The method is performed by a UE and may include at least one of the following:

discarding the system information; lowering a priority of the fake base station cell; lowering a priority of a frequency band where the fake base station cell is located; raising the priority (priorities) of other cell(s) than the fake base station cell in the TA; raising the priority (priorities) of the frequency band(s) where other cell(s) than the fake base station cell in the TA is (are) located; or triggering the UE to perform a cell selection operation.

Here, the priority of a cell or the priority of a frequency band where a cell is located may be for cell reselection. If the priority of cell A is higher than the priority of cell B, when the UE performs cell reselection, reselection to cell A is prioritized, or measurement of cell A is prioritized. If the priority of the frequency band A where cell A is located is higher than the priority of the frequency band B where cell B is located, when the UE performs cell reselection, reselection to the cell where the frequency band A is located is prioritized, or measurement of the frequency band A is prioritized.

In an embodiment, after the UE identifies the cell which broadcasts the system information as a fake base station cell, the UE performs at least one of the following: discarding the system information; lowering the priority of the fake base station cell; lowering the priority of the frequency band where the fake base station cell is located; raising priority (priorities) of other cell(s) than the fake base station cell in the TA; raising the priority (priorities) of the frequency band(s) where other cell(s) than the fake base station cell in the TA is (are) located; and triggering the UE to perform a cell selection operation.

As an example, after the UE identifies the cell which broadcasts the system information as a fake base station cell, the UE discards the system information sent by the fake base station cell.

As an example, after the UE identifies the cell which broadcasts the system information as a fake base station cell, the UE lowers the priority of the fake base station cell from a first priority to a second priority, where when the UE performs cell reselection, reselection to a cell with the first priority is prioritized over reselection to a cell with the second priority.

As an example, the TA includes a cell A, a cell B, and a cell C, where the cell A, the cell B, and the cell C are all cells with the second priority. If the UE identifies that the cell A which broadcasts the system information is a fake base station cell, the priorities of the cell B and the cell C in the TA except the cell A are raised from the second priority to the first priority; or it is also possible to lower the priority of the cell A from the second priority to a third priority. When the UE performs cell reselection, reselection to a cell with the first priority is prioritized over reselection to a cell with the second priority, and reselection to the cell with the second priority is prioritized over reselection to a cell with the third priority.

As an example, after the UE identifies that the cell which broadcasts the system information is a fake base station cell, the UE lowers the priority of the frequency band where the fake base station cell is located from a first priority to a second priority, where when the UE performs measurements for cell reselection, measurement of a frequency band with the first priority is prioritized over measurement of a frequency band with the second priority.

As an example, the TA includes a cell A, a cell B and a cell C, and the frequency bands which the cell A, the cell B and the cell C are located are a frequency band A, a frequency band B and a frequency band C, respectively. The priorities of the frequency band A, the frequency band B and the frequency band C are the second priority. If the UE identifies that the cell A broadcasting the system information is a fake base station cell, the priorities of the frequency band B where the cell B in the TA is located and the frequency band C where the cell C in the TA is located are raised from the second priority to the first priority; or it is also possible to lower the priority of the frequency band A where the cell A is located from the second priority to the third priority. When the UE performs measurements for cell reselection, measurement of the frequency band with the first priority is prioritized over measurement of the frequency band with the second priority, and measurement of the frequency band with the second priority is prioritized over the measurement of the frequency band with the third priority.

As an example, after the UE identifies that the cell which broadcasts the system information is a fake base station cell, the UE may be triggered to perform cell selection. Here, when the UE performs cell selection, it may select a cell which was previously identified as a fake base station cell, or may select other cell except the fake base station cell.

In the embodiments of the present disclosure, after the cell which broadcasts the system information is identified as a fake base station cell, the operation of discarding the system information may be performed, thereby reducing the risk of using wrong system information.

Additionally or alternatively, after identifying that the cell which broadcasts the system information is a fake base station cell, the priority of the fake base station cell and/or the priority of the frequency band where the fake base station cell is located can be lowered, thereby reducing the probability that the fake base station cell is reselected; and/or, the priority (priorities) of other cell(s) in the TA except the fake base station cell can be raised and/or the priority (priorities) of the frequency band(s) of other cell(s) in the TA except the fake base station cell can be raised, so that the probability that other cell(s) in the TA except the fake base station cell is (are) reselected can be increased. In this way, the probability that the fake base station cell is reselected can be reduced, thereby improving the security of system information.

Additionally or alternatively, after the cell which broadcasts the system information is identified as a fake base station cell, the UE can be triggered to perform a cell selection operation. In this way, re-registration with a cell can be performed, and the probability of selecting a fake base station cell for communication can also be reduced to a certain extent, which can also improve the security of system information.

It should be noted that those skilled in the art can understand that the methods provided by the embodiments of the present disclosure can be performed alone or together with some methods in the embodiments of the present disclosure or some methods in related art.

An embodiment of the present disclosure provides an information processing method. The method is performed by a UE and may include: if the UE does not have the digital signature key of the TA, based on receiving of system information carrying the DS information, determining not to authenticate the cell which broadcasts the system information.

Here, the UE not having the digital signature key of the TA includes, but is not limited to, at least one of the following cases where: the UE does not receive the digital signature key of the TA when performing registration; the UE does not obtain the digital signature key of each TA sent by the base station; or the UE does not obtain a correspondence relationship between the digital signature key and TA information of each TA sent by the base station.

As shown in FIG. 6, an embodiment of the present disclosure provides an information processing method. The method is performed by a UE and includes step S61.

In step S61, if the UE does not receive the digital signature key of the TA during registration, in response to receiving the system information carrying the DS information, it is determined not to authenticate the cell which broadcasts the system information.

An embodiment of the present disclosure provides an information processing method. The method is performed by a UE and may include: using the system information after determining not to authenticate the cell which broadcasts the system information.

As an example, when the UE initially registers to a cell, and there is no K-SIG in the TA where the cell is located, the UE does not obtain the K-SIG of the TA. If the UE receives system information carrying the DS information, the UE ignores the DS information in the system information and uses the system information.

As an example, the K-SIG of the TA does not exist in the cell on which the UE camps; however, because the AMF in the core network has changed the configuration information so that the TA supports a digital signature, if the UE does not perform TA update to obtain the K-SIG, there is no K-SIG of the TA in the UE. If the UE receives system information carrying the DS information, the UE can also ignore the DS information in the system information and use the system information.

In this way, in the embodiments of the present disclosure, since the K-SIG of the TA does not exist in the UE, if the UE obtains the system information carrying the DS information, the UE may not authenticate the cell which broadcasts the system information, that is, the UE does not need to know whether the system information is true or false, and the UE may use the system information. This method can adapt to some scenarios where the TA does not introduce a digital signature during the UE registration procedure and the system information is updated when the TA subsequently introduces a digital signature.

It should be noted that those skilled in the art can understand that the methods provided in the embodiments of the present disclosure can be performed alone or together with some methods in the embodiments of the present disclosure or some methods in related art.

The following describes an information processing method performed by a base station, which is similar to the above description of the information processing method performed by the UE. For technical details not disclosed in the embodiments of the information processing method performed by the base station, reference may be made to the description of the examples of the information processing methods performed by UE, and detailed description will be omitted here.

As shown in FIG. 7, an embodiment of the present disclosure provides an information processing method. The method is performed by a base station and includes step S71.

In step S71, when a cell of the base station is located in a preset TA, system information carrying DS information is sent, where the DS information is used for a UE to authenticate a cell which broadcasts the system information.

Sending the system information carrying the DS information in step S71 may include sending first indication information to the UE.

The system information may be various types of system information. For example, the system information may be but is not limited to: SIB1, SIB2, . . . , and/or SIB x.

In an embodiment, the DS information carried in the system information is DS information for the preset TA. For example, the base station broadcasts the system information, and the system information carries the DS information for the preset TA.

The UE may be one or more UEs in a cell of the base station.

In some embodiments, the TA may be a TA of at least one of the following: a TA where a cell on which the UE camps is located; a part of TA in a RA of the UE; all of TA in the RA of the UE; or a TA in a TA list, wherein the TA list is a TA list in the RA.

Here, the RA may include one or more TA lists; one TA list includes one or more TAs; or the RA may include one or more TAs.

Here, a TA may include one or more cells.

In an embodiment, the base station sends at least one of the following information: TA information of each TA; a correspondence relationship between the TA information of each TA and K-SIG of the TA; identity information of each cell; or a correspondence relationship between the identity information of each cell and the TA information.

Here, the TA information may be identity information of a TA, or indication information indicating the identity information of the TA, or the like.

Sending the system information carrying the DS information in step S71 may be: sending the system information carrying the DS information and first information, wherein the first information includes: TA information of the TA where the cell of the base station is located. Here, the first information may be carried in predetermined bit(s) of the system information. In this way, after the UE receives the system information, it can determine, based on the TA information in the system information, whether the cell which broadcasts the system information is located in the TA where the cell on which the UE camps is located.

Sending the system information carrying the DS information in step S71 may be: sending the system information carrying the DS information and second information; wherein the second information includes: identity information of the cell of the base station. Here, the second information may be carried in predetermined bit(s) of the system information. In this way, after the UE receives the system information, it can determine, based on the identity information of the cell in the system information, whether the cell which broadcasts the system information is located in the TA where the cell on which the UE camps is located.

In the embodiments of the present disclosure, when the base station determines that the cell of the base station is located in a preset TA, the base station can send system information carrying DS information; where the DS information is used for the UE to authenticate the cell which broadcasts the system information. In this way, the embodiments of the present disclosure can enable the UE to accurately authenticate the cell which broadcasts the system information based on the DS information. The base station only broadcasts the system information after determining that the cell of the base station is located in the preset TA cell. After receiving the system information, the UE can perform cell authentication based on the digital signature corresponding to the TA. This makes it more difficult for other fake base station cell(s) to impersonate a cell in the TA to broadcast the system information, thus reducing the risk that the UE is attacked by a fake base station cell.

Here, the UE can perform cell authentication based on the digital signature key of the TA where the current cell is located and the DS included in the system information; that is, cell authentication can be implemented based on the digital signature corresponding to the TA.

Moreover, in the embodiments of the present disclosure, one piece of DS information can be used for cell(s) in the entire preset TA. In this way, the same digital signature information can be used for authentication of the entire preset TA.

Moreover, in the embodiments of the present disclosure, the range of cell(s) for which the DS needs to be provided for authentication is specified. For example, it may be the TA where the cell on which the UE camps is located, or one or more TAs in the registration area, or one or more TA lists, and so on.

In some embodiments, the digital signature information includes: a digital signature key (K-SIG); or the digital signature information includes: the digital signature key and time indication information, where the time indication information is used to indicate the validity time of the digital signature key.

An embodiment of the present disclosure provides an information processing method. The method is performed by a base station and includes: when the cell of the base station is located in a preset TA, sending system information carrying DS information; wherein the DS information is used for a UE to identify whether a cell which broadcasts the system information is a fake base station cell or not.

As an example, when the base station sends the system information carrying the DS information to the UE, if the DS information matches DS information obtained based on K-SIG in the UE, it is determined that the cell which broadcasts the system information is not a fake base station cell.

As an example, when the base station sends the system information carrying the DS information to the UE, if the DS information does not match the DS information obtained based on K-SIG in the UE, it is determined that the cell which broadcasts the system information is a fake base station cell.

Here, the UE may generate the DS information from the K-SIG existing in the UE through an algorithm related to the digital signature. The algorithm related to the digital signature that is used for generating the DS information in the UE may be any security algorithm, as long as the algorithm related to the digital signature that is used for generating the DS information in the UE is the same as the algorithm that is used for generating the DS information in the system information.

As an example, when the base station sends the system information carrying the DS information to the UE, if the time indication information in the DS information indicates that the validity time of the system information is a first time period, but the current time is a second time that is not in the first time period, it is determined that the cell which broadcasts the system information is a fake base station cell. Here, the second time may be later or earlier than the first time period.

In this way, in the embodiments of the present disclosure, it can be accurately determined whether the cell which broadcasts the system information is a fake base station cell based on the K-SIG included in the DS, or the K-SIG and time indication information included in the DS.

It should be noted that those skilled in the art can understand that the methods provided in the embodiments of the present disclosure can be performed alone or together with some methods in the embodiments of the present disclosure or some methods in related art.

In order to explain any of embodiments of the present disclosure in further detail, a specific example is provided below.

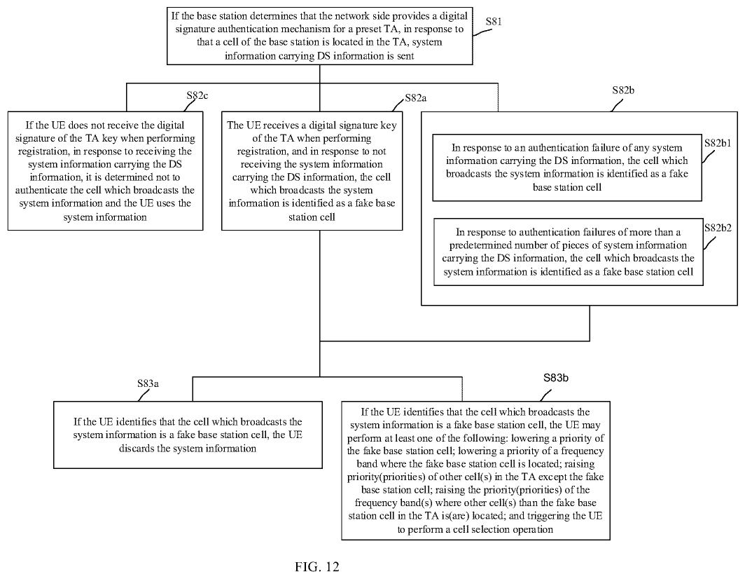

An embodiment of the present disclosure provides an information processing method. The method is performed by a communication device. The communication device includes a base station and a UE. The information processing method includes the following steps as shown in FIG. 12:

In step S81, if the base station determines that the network side provides a digital signature authentication mechanism for a preset TA, in response to that a cell of the base station is located in the TA, system information carrying DS information is sent. The DS information is used for the UE to authenticate a cell which broadcasts the system information.

Here, the TA may be a TA where a cell on which the UE camps is located, or may be a TA in one or more TA lists in an RA, or may be all or part of the TAs in the RA.

In step S82a, the UE receives a digital signature key of the TA when performing registration, and in response to not receiving the system information carrying the DS information, the cell which broadcasts the system information is identified as a fake base station cell.

In step S82b, the UE receives the digital signature key of the TA when performing registration, and in response to an authentication failure of the received system information carrying the DS information, the cell which broadcasts the system information is identified as a fake base station cell.

In step S82b, one of the following is included:

In step S82b1, in response to an authentication failure of any system information carrying the DS information, the cell which broadcasts the system information is identified as a fake base station cell.

As an example, the UE receives multiple pieces of system information carrying the DS information in the cell on which the UE camps, for example, the UE receives PWS, SIB6 and SIB7 carrying the DS information. If the authentication of the SIB6 carrying the DS information by the UE fails, the cell which broadcasts the system information is identified as a fake base station cell. Here, the fake base station cell only attacks the SIB6 and does not attack the PWS and the SIB7.

In step S82b2, in response to authentication failures of more than a predetermined number of pieces of system information carrying the DS information, the cell which broadcasts the system information is identified as a fake base station cell.

As an example, the UE and the network side may agree on a predetermined number N. When the UE receives multiple pieces of system information carrying the DS information in the cell on which the UE camps, such as SIB2, SIB3, SIB4 and SIB5, the UE performs authentication of the multiple pieces of system information. If authentication of more than N pieces of system information carrying the DS information fails, the cell which broadcasts the system information is identified as a fake base station cell. Here, the fake base station cell may attack one or more of SIB2, SIB3, SIB4 and SIB5, or may not attack any one of them. Here, if the system information carrying the DS information fails in authentication, the system information carrying the DS information that fails in the authentication is discarded.

In step S82c, if the UE does not receive the digital signature of the TA key when performing registration, in response to receiving the system information carrying the DS information, it is determined not to authenticate the cell which broadcasts the system information and the UE uses the system information.

As an example, for a UE that initially accesses a cell, the UE does not have any digital signature key of the cell, and the UE does not authenticate the cell which broadcasts the system information; the UE accesses the cell and uses the system information.

As an example, when the UE is camping on a cell, the digital signature key of the cell does not exist; however, because the AMF updates the configuration item information so that the TA where the cell is located supports the digital signature mechanism, and the UE does not perform Tracking Area Update (TAU) to obtain the digital signature key, the UE does not authenticate the cell which broadcasts the system information and uses the system information.

In step S83a, if the UE identifies that the cell which broadcasts the system information is a fake base station cell, the UE discards the system information. In step S83b, if the UE identifies that the cell which broadcasts the system information is a fake base station cell, the UE may perform at least one of the following: lowering a priority of the fake base station cell; lowering a priority of a frequency band where the fake base station cell is located; raising priority (priorities) of other cell(s) in the TA except the fake base station cell; raising the priority (priorities) of the frequency band(s) where other cell(s) than the fake base station cell in the TA is (are) located; and triggering the UE to perform a cell selection operation.

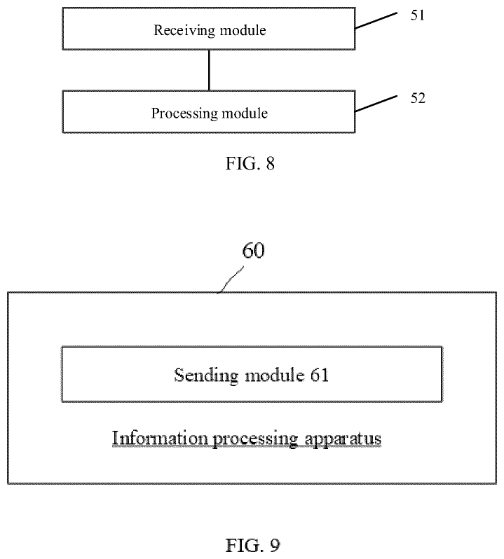

As shown in FIG. 8, an embodiment of the present disclosure provides an information processing apparatus. The apparatus is applied to a UE. The apparatus includes a receiving module 51 and a processing module 52.

The receiving module 51 is configured to receive system information.

The processing module 52 is configured to authenticate a cell which broadcasts the system information based on whether the system information carrying the DS information is received, wherein the system information carrying the DS information is sent by a network device after determining a cell in a preset TA.

In some embodiments, TA includes at least one of the following: a TA where a cell on which the UE camps is located; a part of TA in an RA of the UE, wherein one RA includes one or more TAs; all of TA in the RA of the UE; or a TA in a TA list, wherein the TA list is a TA list in the RA.

An embodiment of the present disclosure provides an information processing apparatus. The apparatus is applied to a UE. The apparatus may include a processing module 52 configured to, if the UE receives a digital signature key of the TA when performing registration, in response to not receiving the system information carrying the DS information, identify the cell which broadcasts the system information as a fake base station cell.

An embodiment of the present disclosure provides an information processing apparatus. The apparatus is applied to a UE. The apparatus may include a processing module 52 configured to, if the UE receives the digital signature key of the TA when performing registration, in response to an authentication failure of the received system information carrying the DS information, identify the cell which broadcasts the system information as a fake base station cell.

An embodiment of the present disclosure provides an information processing apparatus. The apparatus is applied to a UE. The apparatus may include a processing module 52 configured to, in response to an authentication failure of any of the system information carrying the DS information, identify the cell which broadcasts the system information as a fake base station cell.

An embodiment of the present disclosure provides an information processing apparatus. The apparatus is applied to a UE. The apparatus may include a processing module 52 configured to, in response to authentication failures of more than a predetermined number of pieces of system information carrying the DS information, identify the cell which broadcasts the system information as the fake base station cell.

An embodiment of the present disclosure provides an information processing apparatus. The apparatus is applied to a UE. The apparatus may include a processing module 52 configured to discard the system information.

An embodiment of the present disclosure provides an information processing apparatus. The apparatus is applied to a UE. The apparatus may include a processing module 52 configured to lower a priority of the fake base station cell.

An embodiment of the present disclosure provides an information processing apparatus. The apparatus is applied to a UE. The apparatus may include a processing module 52 configured to lower a priority of a frequency band where the fake base station cell is located.

An embodiment of the present disclosure provides an information processing apparatus. The apparatus is applied to a UE. The apparatus may include a processing module 52 configured to raise the priority (priorities) of other cell(s) than the fake base station cell in the TA.

An embodiment of the present disclosure provides an information processing apparatus. The apparatus is applied to a UE. The apparatus may include a processing module 52 configured to raise the priority (priorities) of frequency band(s) where other cell(s) than the fake base station cell in the TA are located.

An embodiment of the present disclosure provides an information processing apparatus. The apparatus is applied to a UE. The apparatus may include a processing module 52 configured to trigger the UE to perform a cell selection operation.

An embodiment of the present disclosure provides an information processing apparatus. The apparatus is applied to a UE. The apparatus may include a processing module 52 configured to, after a cell which broadcasts the system information is identified as a fake base station cell, perform at least one of the following: discarding the system information; lowering the priority of the fake base station cell; lowering the priority of the frequency band where the fake base station cell is located; raising the priority (priorities) of other cell(s) in the TA than the fake base station cell; raising the priority (priorities) of the frequency band(s) where other cell(s) than the fake base station cell in the TA are located; or triggering the UE to perform a cell selection operation.

An embodiment of the present disclosure provides an information processing apparatus. The apparatus is applied to a UE. The apparatus may include a processing module 52 configured to, if the UE does not receive the digital signature key of the TA when performing registration, in response to receiving system information carrying the DS information, determine not to authenticate the cell which broadcasts the system information.

An embodiment of the present disclosure provides an information processing apparatus. The apparatus is applied to a UE. The apparatus may include a processing module 52 configured to use the system information.

An embodiment of the present disclosure provides an information processing apparatus. The apparatus is applied to a UE. The apparatus may include a processing module 52 configured to use the system information after determining not to authenticate the cell which broadcasts the system information.

An embodiment of the present disclosure provides an information processing apparatus. The apparatus is applied to a UE. The apparatus may include a processing module 52 configured to use the system information after identifying that the cell which broadcasts the system information is not a fake base station cell.

In some embodiments, the digital signature information includes: a digital signature key; or, the digital signature information includes: a digital signature key and time indication information, where the time indication information is used to indicate the validity time of the digital signature key.

It should be noted that those skilled in the art can understand that the embodiments of apparatuses can be implemented alone or together with some other embodiments of apparatuses of the present disclosure or some apparatuses in related art.

Regarding the apparatuses in the above embodiments, the specific manner in which each module performs operations has been described in detail in the embodiments related to the methods, and will not be described in detail here.

As shown in FIG. 9, an embodiment of the present disclosure provides an information processing apparatus 60. The apparatus is applied to a base station. The apparatus 60 includes a sending module 61.

The sending module 61 is configured to, when a cell of the base station is located in a preset TA, send system information carrying DS information, wherein the DS information is used for a UE to authenticate a cell which broadcasts the system information.

In some embodiments, the preset TA may be at least one of the following: a TA where a cell on which the UE camps is located; a part of one or more TAs in an RA of the UE; all of one or more TAs in the RA of the UE; or a TA in a TA list, wherein the TA list is a TA list in the RA.

In some embodiments, the DS information is used for the UE to identify whether the cell which broadcasts the system information is a fake base station cell.

An embodiment of the present disclosure provides an information processing apparatus. The apparatus is applied to a base station. The apparatus may include a sending module 61 configured to broadcast system information carrying the DS information when the cell of the base station is located in a preset TA. The DS information is used for the UE to identify whether the cell which broadcasts the system information is a fake base station cell.

In some embodiments, the digital signature information includes: a digital signature key; or the digital signature information includes: a digital signature key and time indication information, where the time indication information is used to indicate the validity time of the digital signature key.

An embodiment of the present disclosure provides an information processing apparatus. The apparatus is applied to a base station. The apparatus may include a sending module 61 configured to broadcast system information carrying a digital signature key when the cell of the base station is located in the preset TA.

An embodiment of the present disclosure provides an information processing apparatus. The apparatus is applied to a base station. The apparatus may include a sending module 61 configured to broadcast system information carrying a digital signature key and time indication information when the cell of the base station is located in the preset TA.

It should be noted that those skilled in the art can understand that the embodiments of apparatuses of the present disclosure can be implemented alone or together with some other embodiments of apparatuses of the present disclosure or some apparatuses in related art.

Regarding the apparatuses in the above embodiments, the specific manner in which each module performs operations has been described in detail in the embodiments related to the methods, and will not be described in detail here.

An embodiment of the present disclosure provides a communication device, including: a processor; and a memory configured to store instructions executable by the processor; wherein the processor is configured to, when the executable instructions are run, implement the information processing method according to any one of embodiments of the present disclosure.

In an embodiment, the communication device may include, but is not limited to at least one of: a core network device, an access network device and a UE. Here, the access network device includes a base station.

The processor may include various types of storage medium, which may be non-transitory computer storage medium that can continue to memorize information stored thereon after the user equipment is powered off.

The processor may be connected to the memory through a bus or the like, and may be configured to read the executable program stored in the memory, for example, at least one of the methods shown in FIG. 3 to FIG. 7.

An embodiment of the present disclosure further provides a computer storage medium. The computer storage medium having a computer executable program stored there on. When the executable program is executed by a processor, the information processing method according to any one of embodiments of the present disclosure is implemented, for example, at least one of the methods shown in FIG. 3 to FIG. 7.

Regarding the device or the storage medium in the above embodiments, the specific manner in which each module performs operations has been described in detail in the embodiments related to the methods, and will not be described in detail here.

The technical solutions provided by the embodiments of the present disclosure may include the following beneficial effects.

In the embodiments of the present disclosure, the system information can be received through a UE, and the cell broadcasting the system information can be authenticated based on whether the system information carrying the Digital Signature (DS) information is received. The system information carrying the DS information is sent by the network device after determining a cell in a preset Tracking Area (TA). In this way, the embodiments of the present disclosure can enable the UE to accurately authenticate the cell broadcasting the system information based on whether the system information carrying the DS information is received.

And, the system information carrying the DS information is sent by a cell in the preset TA determined by the network device, and after receiving the system information, the UE can authenticate the cell in the TA based on digital signature information corresponding to the TA. This solution makes it more difficult for other fake base station cell(s) to impersonate a cell in the TA to broadcast system information, thereby reducing the risk of the UE being attacked by the fake base station cell(s).

Further example embodiments are listed in the following numbered items.
1. An information processing method, performed by User Equipment (UE), the method including: receiving system information; and authenticating a cell which broadcasts the system information based on whether the system information carrying Digital Signature (DS) information is received, wherein the system information carrying the DS information is sent by a network device after determining a cell in a preset Tracking Area (TA).
2. The method as recited in numbered item 1, wherein the TA includes at least one of: a TA where a cell on which the UE camps is located; a part of TA in a Registration Area (RA) of the UE, wherein one RA includes one or more TAs; all of TA in the RA of the UE; or a TA in a TA list, wherein the TA list is a TA list in the RA.
3. The method as recited in numbered item 1 or 2, wherein authenticating the cell which broadcasts the system information based on whether the system information carrying the DS information is received includes: if the UE receives a digital signature key of the TA when performing registration, in response to not receiving the system information carrying the DS information, identifying the cell which broadcasts the system information as a fake base station cell; or if the UE receives the digital signature key of the TA when performing registration, in response to an authentication failure of the received system information carrying the DS information, identifying the cell which broadcasts the system information as the fake base station cell.
4. The method as recited in numbered item 3, wherein in response to not receiving the system information carrying the DS information, identifying the cell which broadcasts the system information as the fake base station cell includes: in response to an authentication failure of any of the system information carrying the DS information, identifying the cell which broadcasts the system information as the fake base station cell; or in response to authentication failures of more than a predetermined number of pieces of system information carrying the DS information, identifying the cell which broadcasts the system information as the fake base station cell.
5. The method as recited in numbered item 3 or 4, further including at least one of: discarding the system information; lowering a priority of the fake base station cell; lowering a priority of a frequency band where the fake base station cell is located; raising priorities of other cells than the fake base station cell in the TA; raising priorities of frequency bands where other cells than the fake base station cell in the TA are located; or triggering the UE to perform a cell selection operation.
6. The method as recited in numbered item 1, further including: if the UE does not receive a digital signature key of the TA when perform registration, in response to receiving the system information carrying the DS information, determining not to authenticate the cell which broadcasts the system information.
7. The method as recited in numbered item 6, further including: using the system information.
8. The method as recited in numbered item 1 or 2, wherein: the digital signature information includes: a digital signature key; or the digital signature information includes: a digital signature key and time indication information, wherein the time indication information is used to indicate validity time of the digital signature key.
9. An information processing method, performed by a base station, the method including: when a cell of the base station is located in a preset Tracking Area (TA), broadcasting system information carrying Digital Signature (DS) information, wherein the DS information is used for User Equipment (UE) to authenticate a cell which broadcasts the system information.
10. The method as recited in numbered item 9, wherein the TA includes at least one of: a TA where a cell on which the UE camps is located; a part of TA in a Registration Area (RA) of the UE, wherein one RA includes one or more TAs; all of TA in the RA of the UE; or a TA in a TA list, wherein the TA list is a TA list in the RA.
11. The method as recited in numbered item 9 or 10, wherein the DS information is used for the UE to identify whether the cell which broadcasts the system information is a fake base station cell.
12. The method as recited in numbered item 9 or 10, wherein: the digital signature information includes: a digital signature key; or the digital signature information includes: a digital signature key and time indication information, wherein the time indication information is used to indicate validity time of the digital signature key.
13. An information processing apparatus, applied in User Equipment (UE), the apparatus including: a receiving module configured to receive system information; and a processing module configured to authenticate a cell which broadcasts the system information based on whether the system information carrying Digital Signature (DS) information is received, wherein the system information carrying the DS information is sent by a network device after determining a cell in a preset Tracking Area (TA).
14. The apparatus as recited in numbered item 13, wherein the TA includes at least one of: a TA where a cell on which the UE camps is located; a part of TA in a Registration Area (RA) of the UE, wherein one RA includes one or more TAs; all of TA in the RA of the UE; or a TA in a TA list, wherein the TA list is a TA list in the RA.
15. The apparatus as recited in numbered item 13 or 14, wherein the processing module is configured to: if the UE receives a digital signature key of the TA when performing registration, in response to not receiving the system information carrying the DS information, identifying the cell which broadcasts the system information as a fake base station cell; or wherein the processing module is configured to: if the UE receives the digital signature key of the TA when performing registration, in response to an authentication failure of the received system information carrying the DS information, identifying the cell which broadcasts the system information as the fake base station cell.
16. The apparatus as recited in numbered item 15, wherein the processing module is configured to: in response to an authentication failure of any of the system information carrying the DS information, identify the cell which broadcasts the system information as the fake base station cell; or wherein the processing module is configured to: in response to authentication failures of more than a predetermined number of pieces of system information carrying the DS information, identify the cell which broadcasts the system information as the fake base station cell.
17. The apparatus as recited in numbered item 15 or 16, wherein the processing module is configured to perform at least one of: discarding the system information; lowering a priority of the fake base station cell; lowering a priority of a frequency band where the fake base station cell is located; raising priorities of other cells than the fake base station cell in the TA; raising priorities of frequency bands where other cells than the fake base station cell in the TA are located; or triggering the UE to perform a cell selection operation.
18. The apparatus as recited in numbered item 13, wherein the processing module is configured to: if the UE does not receive a digital signature key of the TA when perform registration, in response to receiving the system information carrying the DS information, determine not to authenticate the cell which broadcasts the system information.
19. The apparatus as recited in numbered item 18, wherein the processing module is configured to: use the system information.
20. The apparatus as recited in numbered item 13 or 14, wherein: the digital signature information includes: a digital signature key; or the digital signature information includes: a digital signature key and time indication information, wherein the time indication information is used to indicate validity time of the digital signature key.
21. An information processing apparatus, applied in a base station, the apparatus including: a sending module configured to, when a cell of the base station is located in a preset Tracking Area (TA), broadcast system information carrying Digital Signature (DS) information, wherein the DS information is used for User Equipment (UE) to authenticate a cell which broadcasts the system information.
22. The apparatus as recited in numbered item 21, wherein the TA includes at least one of: a TA where a cell on which the UE camps is located; a part of TA in a Registration Area (RA) of the UE, wherein one RA includes one or more TAs; all of TA in the RA of the UE; or a TA in a TA list, wherein the TA list is a TA list in the RA.
23. The apparatus as recited in numbered item 21 or 22, wherein the DS information is used for the UE to identify whether the cell which broadcasts the system information is a fake base station cell.
24. The apparatus as recited in numbered item 21 or 22, wherein: the digital signature information includes: a digital signature key; or the digital signature information includes: a digital signature key and time indication information, wherein the time indication information is used to indicate validity time of the digital signature key.
25. A communication device, including: a processor; and a memory configured to store instructions executable by the processor; wherein the processor is configured to, when the executable instructions are run, implement the information processing method according to any one of numbered items 1 to 8 or any one of numbered items 9 to 12.
26. A computer storage medium, wherein the computer storage medium stores a computer executable program, and when the executable program is executed by a processor, the information processing method according to any one of numbered items 1 to 8 or any one of numbered items 9 to 12 is implemented.

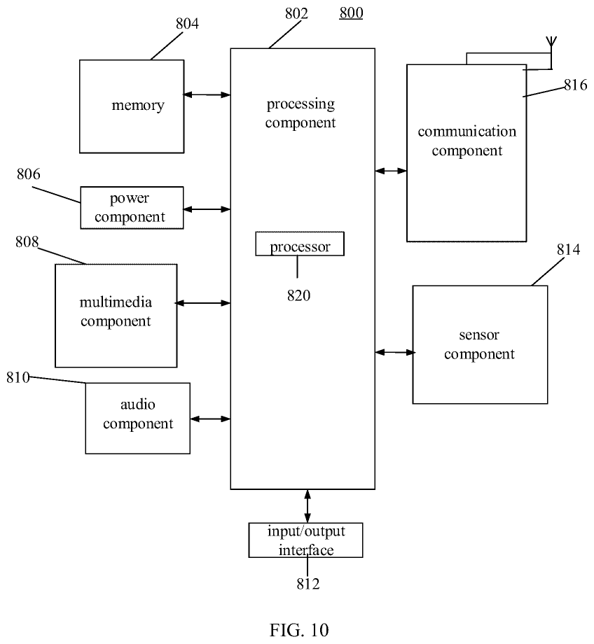

FIG. 10 is a block diagram of a user equipment 800 according to an example embodiment. For example, the user equipment 800 may be a mobile phone, a computer, digital broadcast user equipment, a messaging device, a gaming console, a tablet, a medical device, exercise equipment, a personal digital assistant, and the like.

Referring to FIG. 10, the user equipment 800 may include one or more of the following components: a processing component 801, a memory 804, a power component 806, a multimedia component 808, an audio component 810, an input/output (I/O) interface 812, a sensor component 814, and a communication component 816.

The processing component 802 typically controls overall operations of the user equipment 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the user equipment 800. Examples of such data include instructions for any applications or methods operated on the user equipment 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the user equipment 800. The power component 800 may include a power management system, one or more power sources, and any other components associated with the generation, management, and distribution of power in the user equipment 800.

The multimedia component 808 includes a screen providing an output interface between the user equipment 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and the rear camera may receive an external multimedia datum while the user equipment 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (“MIC”) configured to receive an external audio signal when the user equipment 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the user equipment 800. For instance, the sensor component 814 may detect an open/closed status of the user equipment 800, relative positioning of components, e.g., the display and the keypad, of the user equipment 800, a change in position of the user equipment 800 or a component of the user equipment 800, a presence or absence of user contact with the user equipment 800, an orientation or an acceleration/deceleration of the user equipment 800, and a change in temperature of the user equipment 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the user equipment 800 and other devices. The user equipment 800 can access a wireless network based on a communication standard, such as WiFi, 4G, or 5G, or a combination thereof. In one example embodiment, the communication component 816 receives a broadcast signal or broadcast associated information from an external broadcast management system via a broadcast channel. In one example embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In example embodiments, the user equipment 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In example embodiments, there is also provided a non-transitory computer-readable storage medium including instructions, such as the memory 804 including instructions executable by the processor 820 in the user equipment 800, for performing the above-described methods. For example, the non-transitory computer-readable storage medium may be a ROM, a Random Access Memory (RAM), a CD-ROM, a magnetic tape, a floppy disc, an optical data storage device, and the like.

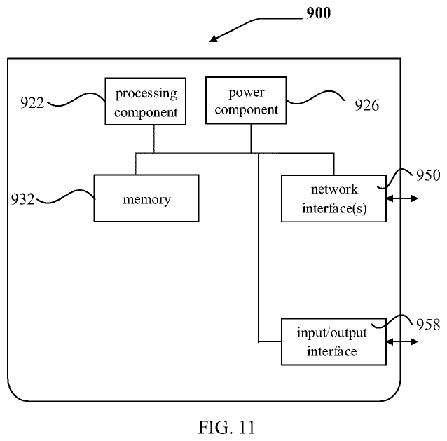

As shown in FIG. 11, an embodiment of the present disclosure shows a structure of a base station. For example, a base station 900 may be provided as a network side device. Referring to FIG. 11, the base station 900 includes a processing component 922 that further includes one or more processors, and memory resources represented by a memory 932 for storing instructions executable by the processing component 922, such as application programs. The application programs stored in the memory 932 may include one or more modules each corresponding to a set of instructions. Further, the processing component 922 is configured to execute the instructions to perform any of the above described methods which are applied at the base station, for example, the methods shown in FIG. 4 to FIG. 10.

The base station 900 may also include a power component 926 configured to perform power management of the base station 900, wired or wireless network interface(s) 950 configured to connect the base station 900 to a network, and an input/output (I/O) interface 958. The base station 900 may operate based on an operating system stored in the memory 932, such as Windows Server™, Mac OS X™, Unix™, Linux™, FreeBSD™, or the like.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

1. An information processing method, performed by User Equipment (UE), the method comprising:
receiving system information; and
authenticating a cell which broadcasts the system information based on whether the system information carrying Digital Signature (DS) information is received, wherein the system information carrying the DS information is sent by a network device after determining a cell in a preset Tracking Area (TA).

2. The method according to claim 1, wherein the preset TA comprises at least one of:
a TA where a cell on which the UE camps is located;
a part of one or more TAs in a Registration Area (RA) of the UE;
all of one or more TAs in the RA of the UE; or
a TA in a TA list, wherein the TA list is a TA list in the RA.

3. The method according to claim 1, wherein authenticating the cell which broadcasts the system information based on whether the system information carrying the DS information is received comprises:
when the UE receives a digital signature key of the preset TA when performing registration, in response to not receiving the system information carrying the DS information, identifying the cell which broadcasts the system information as a fake base station cell; or
when the UE receives the digital signature key of the preset TA when performing registration, in response to an authentication failure of the received system information carrying the DS information, identifying the cell which broadcasts the system information as the fake base station cell.

4. The method according to claim 3, wherein in response to an authentication failure of the received system information carrying the DS information, identifying the cell which broadcasts the system information as the fake base station cell comprises:
in response to an authentication failure of any of one or more pieces of the system information carrying the DS information, identifying the cell which broadcasts the system information as the fake base station cell; or
in response to authentication failures of more than a predetermined number of one or more pieces of system information carrying the DS information, identifying the cell which broadcasts the system information as the fake base station cell.

5. The method according to claim 3, further comprising at least one of:
discarding the system information;
lowering a priority of the fake base station cell;
lowering a priority of a frequency band where the fake base station cell is located;
raising priorities of other cells than the fake base station cell in the preset TA;
raising priorities of frequency bands where other cells than the fake base station cell in the preset TA are located; or
triggering the UE to perform a cell selection operation.

6. The method according to claim 1, further comprising:
when the UE does not receive a digital signature key of the preset TA during registration, in response to receiving the system information carrying the DS information, determining not to authenticate the cell which broadcasts the system information.

7. The method according to claim 6, further comprising:
using the system information.

8. The method according to claim 1, wherein:
the DS information comprises: a digital signature key; or
the DS information comprises: a digital signature key and time indication information, wherein the time indication information is used to indicate validity time of the digital signature key.

9. An information processing method, performed by a base station, the method comprising:
when a cell of the base station is located in a preset Tracking Area (TA), broadcasting system information carrying Digital Signature (DS) information, wherein the DS information is used for User Equipment (UE) to authenticate a cell which broadcasts the system information.

10. The method according to claim 9, wherein the preset TA comprises at least one of:
a TA where a cell on which the UE camps is located;
a part of one or more TAs in a Registration Area (RA) of the UE;
all of one or more TAs in the RA of the UE; or
a TA in a TA list, wherein the TA list is a TA list in the RA.

11. The method according to claim 9, wherein the DS information is used for the UE to identify whether the cell which broadcasts the system information is a fake base station cell.

12. The method according to claim 9, wherein:
the DS information comprises: a digital signature key; or
the DS information comprises: a digital signature key and time indication information, wherein the time indication information is used to indicate validity time of the digital signature key.

13.-24. (canceled)

25. A communication device, comprising:
a processor; and
a memory configured to store instructions executable by the processor;
wherein the processor is configured to:
receiving system information; and
authenticating a cell which broadcasts the system information based on whether system information carrying Digital Signature (DS) information is received, wherein the system information carrying the DS information is sent by a network device after determining a cell in a preset Tracking Area (TA).

26. A non-transitory computer storage medium, wherein the computer storage medium stores a computer executable program, and when the executable program is executed by a processor, the information processing method according to claim 1 is implemented.

27. The communication device according to claim 25, wherein the preset TA comprises at least one of:
a TA where a cell on which the UE camps is located;
a part of one or more TAs in a Registration Area (RA) of the UE;
all of one or more TAs in the RA of the UE; or
a TA in a TA list, wherein the TA list is a TA list in the RA.

28. The communication device according to claim 25, wherein the processor is configured to:
when the UE receives a digital signature key of the preset TA when performing registration, in response to not receiving the system information carrying the DS information, identify the cell which broadcasts the system information as a fake base station cell; or
when the UE receives the digital signature key of the preset TA when performing registration, in response to an authentication failure of the received system information carrying the DS information, identify the cell which broadcasts the system information as the fake base station cell.

29. The communication device according to claim 28, wherein the processor is configured to:
in response to an authentication failure of any of one or more pieces of system information carrying the DS information, identify the cell which broadcasts the system information as the fake base station cell; or
in response to authentication failures of more than a predetermined number of one or more pieces of system information carrying the DS information, identify the cell which broadcasts the system information as the fake base station cell.

30. The communication device according to claim 28, wherein the processor is further configured to perform at least one of:
discarding the system information;
lowering a priority of the fake base station cell;
lowering a priority of a frequency band where the fake base station cell is located;
raising priorities of other cells than the fake base station cell in the preset TA;
raising priorities of frequency bands where other cells than the fake base station cell in the preset TA are located; or
triggering the UE to perform a cell selection operation.

31. A communication device, comprising:
a processor; and
a memory configured to store instructions executable by the processor;
wherein the processor is configured to perform the method according to claim 9.

32. A non-transitory computer storage medium, wherein the computer storage medium stores a computer executable program, and when the executable program is executed by a processor, the information processing method according to claim 9 is implemented.
